(19) United States
(12) Patent Application Publication
(10) Pub. No.: US 2002/0135674 A1
(43) Pub. Date: Sep. 26, 2002

(54) Video providing apparatus

(75) Inventors: Eiji Shimizu, Osaka (JP); Seiji Yamaguchi, Hyogo (JP); Takahisa Ando, Osaka (JP)

Correspondence Address: ARMSTRONG,WESTERMAN & HATTORI, LLP, 1725 K STREET, NW., SUITE 1000, WASHINGTON, DC, 20006, US

(73) Assignee: Eiji Shimizu, Takatsuki-shi (JP)

(21) Appl. No.: 10/100,047

(22) Filed: Mar. 19, 2002

(30) Foreign Application Priority Data
Mar. 26, 2001 (JP) 2001-088880

(51) Int. Cl. H04N 9/47; H04N 7/18

(52) U.S. Cl. 348/62

(57) ABSTRACT

A video providing apparatus comprises a video projector, a helmet-shaped head mounting tool, a mirror, a mirror supporting bar, an image pick-up device, and a signal cable. The video projector feeds video light (a bundle of parallel light beams) to the center of the eye of a viewer, for example, by a light condenser device. The video light is directly projected on the retina without being affected by the lens function in the crystalline lens of the eye by Maxwellian view. Accordingly, clear enlarged video can be fed to a person who has a serious disorder or the like in the focus adjusting function of the crystalline lens, to assist the person in reading or the like.

### BACKGROUND OF THE INVENTION

1. Field of the Invention

The present invention relates to a video providing apparatus used for assisting in reading or the like.

Conventionally, enlargement readers have been proposed as apparatuses for assisting people with weak eyesight in reading or the like. The enlargement reader comprises an image pick-up device for producing a video signal on the basis of video picked up, signal processing means for processing the video signal from the image pick-up device and producing a video signal to be fed to a monitor (a commercially available television set, etc.) and an enlargement optical system for feeding enlarged video to the image pick-up device. Further, an enlargement reader of such a type that an image is displayed on a glasses-type display in place of the monitor has been also proposed.

The conventional enlargement readers become superior auxiliary apparatuses for people who cannot easily read small characters because of weak eyesight. However, in conventional enlargement readers which are limited to the mere enlarging function of characters or the like, it is difficult to provide clear video to people who have a serious disorder in the focus adjusting function of the crystalline lens or the like.

In view of the foregoing circumstances, an object of the present invention is to provide a video providing apparatus capable of providing clear video to not only a person who cannot easily read small characters because of weak eyesight but also a person who has a serious disorder in the focus adjusting function of the crystalline lens or the like, to assist the person in reading or the like.

### SUMMARY OF THE INVENTION

A video providing apparatus according to the present invention is characterized by comprising video providing means, comprising a spatial light modulator (SLM), a light source device for projecting parallel light beam on the spatial light modulator, and a light condenser device for converging video light obtained by projecting the parallel light beam on the spatial light modulator, for causing a viewer to view video by Maxwellian view; and signal processing means for processing a video signal, enlarging the image, and producing a video signal to be fed to the spatial light modulator.

In the above-mentioned configuration, when newspaper characters or the like are picked up by the image pick-up device, for example, an enlarged video signal is produced by the signal processing means, and is fed to the spatial light modulator. Enlarged video (a bundle of parallel light beams) of the newspaper characters or the like produced by the spatial light modulator is directly projected on the retina without being affected by the lens function in the crystalline lens of the eye by Maxwellian view. Accordingly, clear enlarged video can be also fed to not only a person who cannot easily read small characters because of weak eyesight but also a person who has a serious disorder in the focus adjusting function of the crystalline lens or the like, to assist the person in reading or the like.

A video providing apparatus according to the present invention is characterized by comprising video providing means, comprising a spatial light modulator, a light source device for projecting parallel light beam on the spatial light modulator, and a light condenser device for converging video light obtained by projecting the parallel light beam on the spatial light modulator, for causing a viewer to view video by Maxwellian view; an image pick-up device for producing a video signal on the basis of video picked up; signal processing means for processing a video signal from the image pick-up device and producing a video signal to be fed to the spatial light modulator; and an enlargement optical system for feeding enlarged video to the image pick-up device.

In the above-mentioned configuration, newspaper characters or the like are picked up by the image pick-up device through the enlargement optical system so that an enlarged video signal is produced, and is fed to the spatial light modulator. Enlarged video (a bundle of parallel light beams) of the newspaper characters or the like produced by the spatial light modulator is directly projected on the retina without being affected by the lens function in the crystalline lens of the eye by Maxwellian view. Accordingly, clear enlarged video can be fed to not only a person who cannot easily read small characters because of weak eyesight but also a person who has a serious disorder in the focus adjusting function of the crystalline lens or the like, to assist the person in reading or the like.

A video providing apparatus according to the present invention is characterized by comprising video providing means, comprising a spatial light modulator, a light source device for projecting parallel light beam on the spatial light modulator, and a light condenser device for converging video light obtained by projecting the parallel light beam on the spatial light modulator, for causing a viewer to view video by Maxwellian view; and signal processing means for performing at least one of contrast enhancement processing, edge enhancement processing, and processing for coloring a white video area and producing a video signal to be fed to the spatial light modulator.

In the above-mentioned configuration, at least one of the contrast enhancement processing, the edge enhancement processing, and the processing for coloring the white video area is performed, thereby making it possible to provide the characters or the like to the viewer in the form of video easier to see.

In these configurations, the video providing apparatus may comprise a color film for giving a color to white, or may be so constructed that the light source device emits color light.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustration showing a head-mounted type video providing apparatus according to an embodiment of the present invention; and

FIG. 2 is an illustration showing how video is provided to a viewer.

### DESCRIPTION OF THE PREFERRED EMBODIMENT

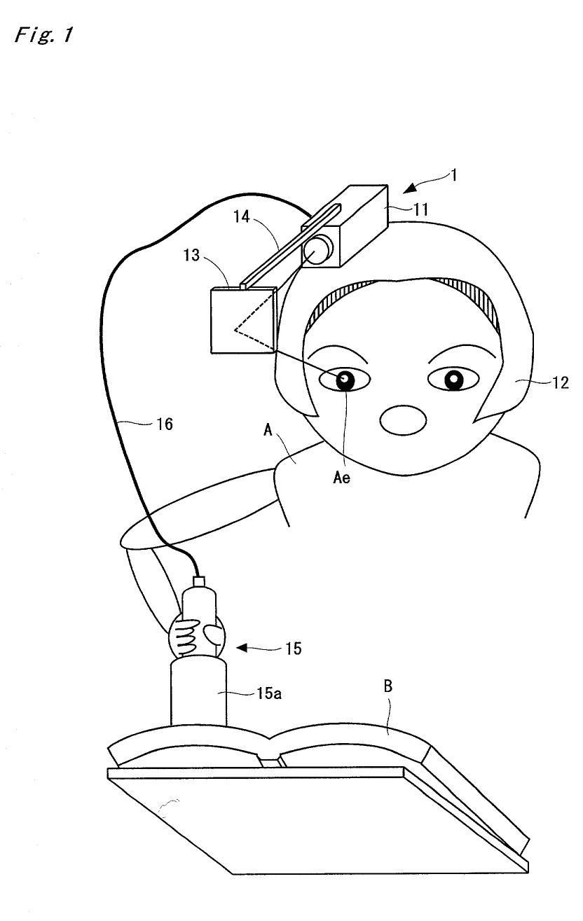

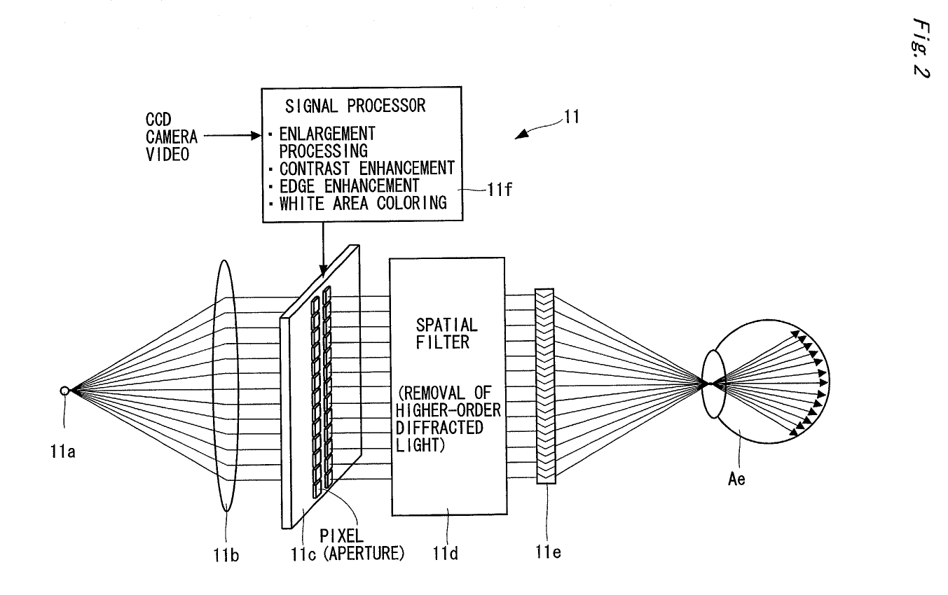

A video providing apparatus according to an embodiment of the present invention will be described on the basis of FIGS. 1 and 2.

FIG. 1 is an illustration showing a head-mounted type video providing apparatus 1. The video providing apparatus 1 comprises a video projector 11, a helmet-shaped head mounting tool 12, a mirror 13, a mirror supporting bar 14, an image pick-up device 15, and a signal cable 16. The video projector 11 is provided so as to be rotatable in each type of direction on the head mounting tool 12. Further, the mirror 13 is provided so as to be rotatable in each type of direction at one end of the mirror supporting bar 14 so that video light emitted from the video projector 11 can be accurately introduced into, for example, the center of the pupil of the eye Ae of a viewer A.

The image pick-up device 15 is composed of a CCD camera, for example, and is placed on a printing surface of a book B by the hand of the viewer A. The image pick-up device 15 is provided with a cylinder 15a, so that the distance between a CCD camera lens and the printing surface is kept optimum in a state where a leading end of the cylinder 15a is abutted against the printing surface. The signal cable 16 feeds a video signal outputted from the image pick-up device 15 to a signal processor 11f (see FIG. 2) in the video projector 11.

FIG. 2 illustrates the specific configuration of the video projector 11, and shows how video light emitted therefrom is introduced into the eye Ae (the mirror 13 is omitted for simplicity). The video projector 11 comprises a laser light source 11a, a collimator lens 11b for changing light emitted from the laser light source 11a into parallel light beam, a liquid crystal display panel 11c which is a spatial light modulator, a spatial filter 11d, a hologram light condenser device 11e, and a signal processor 11f. Letting f be the focal length of the hologram light condenser device lie, the hologram light condenser device 11e is arranged at a distance of f from the center of the eye of the viewer. Consequently, the viewer A views video by Maxwellian view. An image displayed on the liquid crystal display panel 11c is fed to the viewer A at a large focal depth.

The parallel light beams which have transmitted pixels (apertures) in the liquid crystal display panel 11c include higher-order diffracted light beams. When the parallel light beams are incident on the hologram light condenser device 11e as they are, video becomes a multiple image. In the present embodiment, however, only zero-order light beams are taken out by arranging the spatial filter 11d, thereby preventing the video from being a multiple image. A video signal which has been subjected to video enlargement processing (for example, pixel interpolation processing) by the signal processor 11f is fed to the liquid crystal display panel 11c.

In such a configuration, when the book B is picked up by the image pick-up device 15, an enlarged video signal is produced by the signal processor 11f, and is fed to the liquid crystal display panel 11c. Enlarged video (a bundle of parallel light beams) of the book B which is produced by the liquid crystal display panel 11c is converged by the hologram light condenser device lie, and is directly projected on the retina without being affected by the lens function in the crystalline lens of the eye Ae by Maxwellian view. Accordingly, clear enlarged video can be also fed to not only a person who cannot easily read small characters because of weak eyesight but also a person who has a serious disorder in the focus adjusting function of the crystalline lens or the like, to assist the person in reading or the like.

In the present embodiment, the signal processor 11f digitizes the video signal from the image pick-up device 15 by an analog-to-digital converter (not shown), to perform contrast enhancement processing, edge enhancement processing, and white area coloring processing by digital signal processing.

The contrast enhancement is processing using, in a case where the density of video picked up is distributed in a narrow range of a density width (a luminance width) which can be represented by a video display system, the density width to the full by operation processing. If processing is not gradation but binarization, it is processing for coloring a signal having a density of not less than a certain threshold white and coloring a signal having a density of not more than the threshold black.

The edge enhancement is processing for sharpening the rise of a signal, and is performed using a high-frequency enhancement filter (an operation processing circuit), for example.

The white area coloring is processing for not producing white and black signals in the binarization but producing a chromatic signal in place of the white signal, for example, producing yellow and black signals or blue and black signals. In the white area coloring, the image pick-up device 15 need not be a color image pick-up device. Signal processing for subjecting a signal to coloring by the signal processor 11f using a color liquid crystal display panel as the liquid crystal display panel 11c. By the signal processing, characters or the like can be provided to a viewer in the form of video easier to see. The white area coloring can be also realized by affixing a yellow or blue film to a black-and-white liquid crystal display panel not to particularly perform signal processing. Further, the white area coloring may be performed by the laser light source 11a emitting color light beams.

Although in the above-mentioned embodiment, the enlarged video of the characters or the like picked up by the signal processing, the enlarged video may be optically produced by comprising a zoom lens as a lens in the image pick-up device 15.

Although description was made of a case where the hologram light condenser device 11e is illustrated as a light condenser device, a convex lens or a concave mirror can be used in place of the hologram light condenser device 11e. In the case of the concave mirror, it can be arranged as means for changing an optical axis (e.g., a beam splitter (a half mirror) or a mirror 13). Further, although the transmission type liquid crystal display panel 11c is illustrated as a spatial light modulator, another transmission type video display panel, a reflection type liquid crystal display panel, another reflection type video display panel (DMD: a digital micromirror device), etc. can be used.

Furthermore, video light may be directly projected on the eye Ae of the viewer A without using the mirror 13. The mirror 13 may have the function of the hologram light condenser device 11e. Although the video projector 11 is supported by the helmet-shaped head mounting tool 12, it may be constructed as one of a glasses type or a head-mounted display type. Further, it may be in such a form that the video projector 11 is placed on a desk, and the viewer brings his or her eyes near the video projector 11. Although the image pick-up device 15 of such a type operated in hand is illustrated, it may be fixedly arranged above a stand on which the book B is placed.

Furthermore, a signal to be inputted to the signal processor 11f shown in FIG. 2 may be not only camera video but also a signal for video media which is enjoyed by a person with weaksight, for example, computer output video, television receiving video, or a video (VTR) output video. Although a laser light source is used as the light source, an LED (Light Emitting Diode), a small-sized lamp, or a light source which is guided by an optical fiber may be used.

As described in the foregoing, according to the present invention, the enlarged video of the newspaper characters or the like is directly projected on the retina without being affected by the lens function in the crystalline lens of the eye by Maxwellian view, thereby producing such an effect that clear enlarged video can be fed to not only a person who cannot easily read the small characters because of weak eyesight but also a person who has a serious disorder in the focus adjusting function of the crystalline lens or the like, to assist the person in reading or the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A video providing apparatus comprising:
video providing means, comprising a spatial light modulator, a light source device for projecting parallel light beam on said spatial light modulator, and a light condenser device for converging video light obtained by projecting the parallel light beam on said spatial light modulator, for causing a viewer to view video by Maxwellian view; and
signal processing means for processing a video signal, enlarging the image, and producing a video signal to be fed to said spatial light modulator.

2. A video providing apparatus comprising:
video providing means, comprising a spatial light modulator, a light source device for projecting parallel light beam on said spatial light modulator, and a light condenser device for converging video light obtained by projecting the parallel light beam on said spatial light modulator, for causing a viewer to view video by Maxwellian view;
an image pick-up device for producing a video signal on the basis of video picked up;
signal processing means for processing a video signal from said image pick-up device and producing a video signal to be fed to said spatial light modulator; and
an enlargement optical system for feeding enlarged video to said image pick-up device.

3. A video providing apparatus comprising:
video providing means, comprising a spatial light modulator, a light source device for projecting parallel light beam on said spatial light modulator, and a light condenser device for converging video light obtained by projecting the parallel light beam on said spatial light modulator, for causing a viewer to view video by Maxwellian view; and
signal processing means for performing at least one of contrast enhancement processing, edge enhancement processing, and processing for coloring a white video area and producing a video signal to be fed to said spatial light modulator.

4. The video providing apparatus according to claim 1, further comprising
a color film for giving a color to white.

5. The video providing apparatus according to claim 2, further comprising
a color film for giving a color to white.

6. The video providing apparatus according to claim 3, further comprising
a color film for giving a color to white.

7. The video providing apparatus according claim 1, wherein
the light source device emits color light.

8. The video providing apparatus according claim 2, wherein
the light source device emits color light.

9. The video providing apparatus according claim 3, wherein
the light source device emits color light.
